(19) United States
(12) Patent Application Publication
(10) Pub. No.: US 2017/0167448 A1
(43) Pub. Date: Jun. 15, 2017

(54) ENGINE SYSTEM

(71) Applicant: HYUNDAI MOTOR COMPANY, Seoul (KR)

(72) Inventor: Choo Saeng CHOI, Seongnam-si (KR)

(21) Appl. No.: 15/239,328

(22) Filed: Aug. 17, 2016

(30) Foreign Application Priority Data
Dec. 11, 2015 (KR) 10-2015-0176901

(51) Int. Cl. F02M 26/04; F02M 26/23

(52) U.S. Cl. CPC F02M 26/04; F02M 26/23

(57) ABSTRACT

An engine system includes an intake line into which fresh air flows, an engine including a plurality of combustion chambers for generating driving torque by combustion of a fuel, an exhaust line in which exhaust gas exhausted from the combustion chambers flows, a recirculation line branched from the exhaust line and joined to the intake line, a T pipe disposed at a portion where the intake line and the recirculation line are joined, a turbocharger including a turbine rotated by the exhaust gas exhausted from the combustion chambers and a compressor rotated together with the turbine and compressing mixed gas exhausted from the T pipe, and a hot-water pipe disposed at the T pipe, wherein a coolant for cooling the combustion chamber of the engine flows.

### CROSS-REFERENCE TO RELATED APPLICATION

This application claims the benefit of priority to Korean Patent Application No. 10-2015-0176901, filed with the Korean Intellectual Property Office on Dec. 11, 2015, the entire contents of which are incorporated herein by reference.

### TECHNICAL FIELD

The present disclosure relates to an engine system. More particularly, the present disclosure relates to an engine system that prevents generation of condensate water when high temperature and humidity EGR gas and low temperature fresh air are mixed.

### BACKGROUND

An engine mixes air and fuel, and generates driving power by burning the mixed gas. In order to obtain a required output power and combustion efficiency, sufficient air should be supplied to the engine. A turbocharger may be used to increase combustion efficiency and supply sufficient air to the engine.

Generally, a turbine of the turbocharger is rotated by pressure of exhaust gas exhausted from the engine, a compressor of the turbocharger compresses fresh air flowing in from the outside, and the compressed air is supplied to a combustion chamber of the engine. The turbocharger has been applied to diesel engines, and has also been applied to gasoline engines.

Further, NOx (nitrous oxide) included in the exhaust gas is regulated as an air pollutant, and research has been carried out in order to study ways to reduce the amount of NOx in exhaust gases.

An exhaust gas recirculation (EGR) system mounted in a vehicle reduces exhaust gases produced by the vehicle. Generally, the amount of NOx in the exhaust gas is increased in an oxygen rich air mixture, and the air mixture is properly combusted. Therefore, the exhaust gas recirculation system reduces the amount of NOx in the exhaust gas as a consequence of a part (e.g., 5-20%) of the exhaust gas being recirculated to the air mixture in order to reduce the oxygen ratio in the air mixture and thus hinder combustion.

An LP-EGR (low pressure EGR) system is a type of exhaust gas recirculation (EGR) system. The LP-EGR system recirculates the exhaust gas passing through the turbine of the turbocharger to an intake path of an upstream side of the compressor.

However, the exhaust gas recirculated by the EGR system has high temperature and humidity. Therefore, condensate water is generated when the recirculated exhaust gas and the external air having a low temperature are mixed.

Particularly, very cold external air (e.g., minus 20 to 40° C.) may flow into the engine when an external temperature is low, such as in a winter season. Further, the recirculated exhaust gas may have a high temperature (e.g., 100 to 150° C.) and high humidity (e.g., 15%).

At this time, moisture included in the exhaust gas may condense and ice crystals may be generated when the external air and the exhaust gas are mixed. The ice crystals may impact a compressor wheel that rotates at a high speed, and the compressor wheel may be damaged.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide an engine system that prevents generation of ice crystals when high temperature and humidity EGR gas and low temperature fresh air are mixed.

An engine system according to an exemplary embodiment of the present disclosure may include: an intake line into which fresh air flows; an engine including a plurality of combustion chambers for generating driving torque by combustion of fuel; an exhaust line in which exhaust gas exhausted from the combustion chambers flows; a recirculation line branched from the exhaust line and joined to the intake line; a T pipe disposed at a portion where the intake line and the recirculation line are joined; a turbocharger including a turbine rotated by the exhaust gas exhausted from the combustion chambers and a compressor rotated together with the turbine and compressing mixed gas exhausted from the T pipe; and a hot-water pipe disposed at the T pipe, wherein a coolant for cooling the combustion chamber of the engine flows.

The T pipe may include: an intake inflow portion connected to the intake line; a recirculated exhaust gas inflow portion connected to the recirculation line; and a mixed gas exhaust portion in which the fresh air flowing into the intake inflow portion and the recirculated exhaust gas flowing into the recirculated exhaust gas inflow portion are mixed and the mixed gas is exhausted to the compressor of the turbocharger.

An intake inlet may be formed at the intake inflow portion, a recirculation gas inlet may be formed at the recirculated exhaust gas inflow portion, a mixed gas outlet may be formed at the mixed gas exhaust portion, and the intake inlet, the recirculation gas inlet, and the mixed gas outlet may communicate with each other.

The hot-water pipe may be disposed on an external circumference of the mixed gas exhaust portion.

The hot-water pipe may be connected to an engine cooling line in which the coolant cooling the engine flows.

The intake line, the recirculation line, and the T pipe may be integrally formed.

According to an exemplary embodiment of the present disclosure, since a hot-water pipe flowing hot coolant is disposed at a T pipe that mixes external air and recirculated exhaust gas, it is possible to prevent generation of ice crystals when the external air and recirculated exhaust gas are mixed.

Further, since the ice crystals are not generated when the external air and the recirculated exhausted gas are mixed, it is possible to prevent the compressor of a turbocharger from being damaged by the ice crystals.

### BRIEF DESCRIPTION

The drawings are provided for reference in describing exemplary embodiments of the present disclosure, and the spirit of the present disclosure should not be construed only by the accompanying drawings.

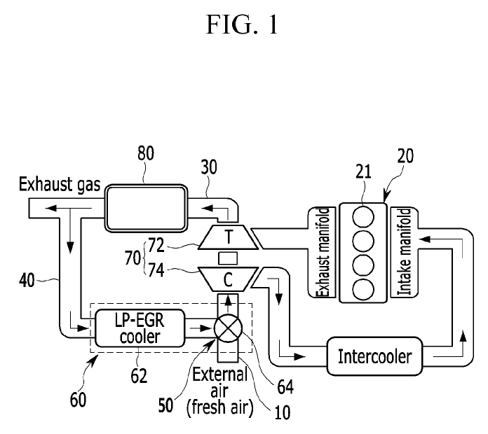

FIG. 1 is a schematic view illustrating an engine system according to an exemplary embodiment of the present disclosure.

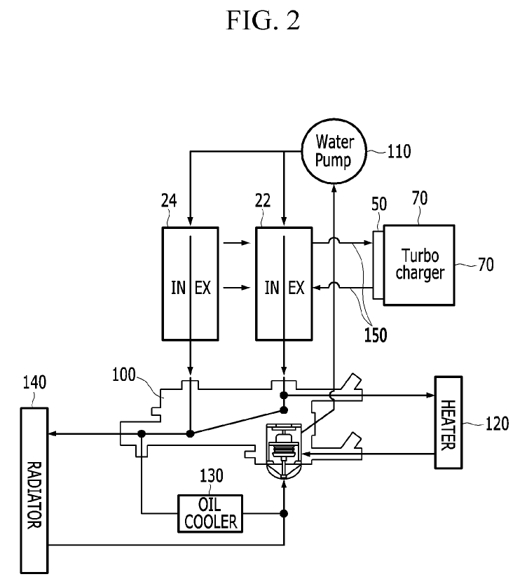

FIG. 2 is a schematic view illustrating an engine cooling system according to an exemplary embodiment of the present disclosure.

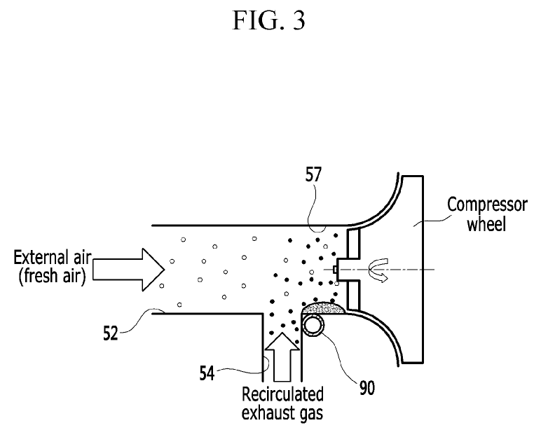

FIG. 3 is a cross-sectional view illustrating a T pipe according to an exemplary embodiment of the present disclosure.

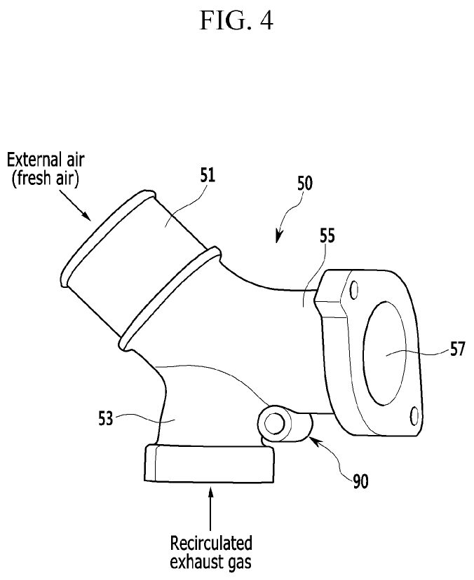

FIG. 4 is a perspective view illustrating a T pipe according to an exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art will realize, the described embodiments may be modified in various different ways, all without departing from the spirit or scope of the present disclosure.

In order to clearly describe the present disclosure, portions that are not connected with the description will be omitted. Like reference numerals designate like elements throughout the specification.

In addition, the size and thickness of each configuration shown in the drawings are arbitrarily shown for better understanding and ease of description, but the present disclosure is not limited thereto. In the drawings, the thickness of layers, films, panels, regions, etc., may be exaggerated for clarity.

Hereinafter, an engine system according to an exemplary embodiment of the present disclosure will be described in detail with reference to accompanying drawings.

FIG. 1 is a schematic view illustrating an engine system according to an exemplary embodiment of the present disclosure.

As shown in FIG. 1, an engine system according to an exemplary embodiment of the present disclosure may include an intake line 10 into which fresh air flows, an engine 20 including a plurality of combustion chambers 21 generating driving torque by combustion of fuel, an exhaust line 30 in which exhaust gas exhausted from the combustion chambers 21 flows, a recirculation line 40 branched from the exhaust line 30 and joined to the intake line 10, a T pipe 50 disposed at a portion where the intake line 10 and the recirculation line 40 are joined, and a turbocharger 70 that compresses the fresh air flowing in through the intake line 10 and the recirculation gas flowing in through the recirculation line 40 and supplying the compressed air to the combustion chambers 21.

The turbocharger 70 may include a turbine 72 rotated by the exhaust gas exhausted from the combustion chamber 21, and a compressor 74 being rotated by rotation forces of the turbine and turbocharging the external air and the recirculated exhaust gas.

An exhaust gas purification apparatus 80 that purifies the exhaust gas exhausted from the combustion chamber 21 may be disposed at the exhaust line 30. The exhaust gas purification apparatus 80 may include an LNT (lean NOx trap), a diesel oxidation catalyst (diesel oxidation catalyst) and a DPF (diesel particulate filter).

The engine system according to an exemplary embodiment of the present disclosure may further include an exhaust gas recirculation (EGR) apparatus, in which a part of the exhaust gas exhausted from the combustion chamber 21 is resupplied to the combustion chamber 21. The exhaust gas recirculation apparatus may be an LP-EGR (low pressure EGR) apparatus 60.

The low pressure EGR 60 may include an LP-EGR cooler 62 and an EGR valve 64 disposed at the recirculation line 40. An amount of the recirculation gas resupplied to the combustion chamber may be adjusted by opening the EGR valve. The EGR valve may be disposed at the T pipe 50.

The recirculation line 40 may be branched at a downstream side of the exhaust gas purification apparatus 80 and joined at the intake line 10.

Hereinafter, a cooling system of the engine is described in detail. FIG. 2 is a schematic view illustrating an engine cooling system according to an exemplary embodiment of the present disclosure.

As shown in FIG. 2, coolant stored in a coolant tank may be passed through a cylinder head 24, a cylinder block 22, a heater 120, an oil cooler 130, a radiator 140, and a turbocharger 70 by a water pump 110. The turbocharger 70 may share a coolant path with the cylinder head 24 and the cylinder block 22.

The coolant passing through the cylinder block 22 and the cylinder head 24 of the engine 20 may pass through the turbocharger 70. Throughout this specification, a cooling line through which the coolant passing through the cylinder block 22 and the cylinder head 24 of the engine 20 and flowing in the turbocharger 70 flows is called an engine cooling line 150.

Hereinafter, the T pipe according to an exemplary embodiment of the present disclosure will be described in detail with reference to accompanying drawings.

FIG. 3 is a cross-sectional view illustrating a T pipe according to an exemplary embodiment of the present disclosure. FIG. 4 is a perspective view illustrating a T pipe according to an exemplary embodiment of the present disclosure.

As shown in FIG. 3 and FIG. 4, the T pipe 50 may be a T-shaped pipe disposed at a portion where the recirculation line 40 and the intake line 10 are joined. The T pipe 50 may include an intake inflow portion 51 connected to the intake line 10, a recirculated exhaust gas inflow portion 53 connected to the recirculation line 40, and a mixed gas exhaust portion 55 exhausting the intake air and the recirculated exhaust gas to the compressor 74. The external air flowing into the intake inflow portion 51 and the recirculated exhaust gas may be mixed in the mixed gas exhaust portion 55.

An intake inlet 52 may be formed at the intake inflow portion 51, a recirculation gas inlet 54 may be formed at the recirculated exhaust gas inflow portion 53, and a mixed gas outlet 57 may be formed at the mixed gas exhaust portion 55. The intake inlet 52, the recirculation gas inlet 54, and the mixed gas outlet 57 may communicate with each other, such that the external air flowing into the intake inlet 52 and the recirculated exhaust gas flowing into the recirculation gas inlet 54 are mixed and supplied to the compressor 74 of the turbocharger 70. The compressor 74 may compress the mixed gas (the external air and the recirculated exhaust gas) and the compressed gas may be supplied to the combustion chamber 21.

In an exemplary embodiment of the present disclosure, it may be assumed that the intake line 10 and the recirculation line 40 connected to the T pipe 50 are separately formed. However, the disclosure is not limited to the disclosed embodiments, and the T pipe 50 may integrally formed with the intake line 10 and the recirculation line 40.

A hot-water pipe 90, in which coolant for cooling the combustion chamber 21 of the engine 20 flows, may be provided at the T pipe 50. The hot-water pipe 90 may be disposed on an external circumference of the mixed gas exhaust portion 55. The hot-water pipe 90 may be connected to the engine cooling line 150 in which the coolant cooling the engine 20 flows. Since the hot-water pipe 90 may be connected to the engine cooling line 150, hot coolant for cooling the engine 20 flows in the hot-water pipe 90, and the mixed gas exhaust portion 55 of the T pipe 50 is heated by the hot coolant flowing through the hot-water pipe 90.

Therefore, the ice crystals will not be generated when mixing the recirculated exhaust gas and the external air in the mixed gas exhaust portion 55, so it is possible to prevent damage to the compressor wheel by the ice crystals.

While this disclosure has been described in connection with what is presently considered to be practical exemplary embodiments, it is to be understood that the disclosure is not limited to the disclosed embodiments, but is intended to cover various modifications and equivalent arrangements included within the spirit and scope of the appended claims.

What is claimed is:

1. An engine system comprising:
an intake line into which fresh air flows;
an engine including a plurality of combustion chambers for generating driving torque by combustion of a fuel;
an exhaust line in which exhaust gas exhausted from the combustion chambers flows;
a recirculation line branched from the exhaust line and joined to the intake line;
a T pipe disposed at a portion where the intake line and the recirculation line are joined;
a turbocharger including a turbine rotated by the exhaust gas exhausted from the combustion chambers and a compressor rotated together with the turbine and compressing mixed gas exhausted from the T pipe; and
a hot-water pipe disposed at the T pipe, wherein a coolant for cooling the combustion chamber of the engine flows.

2. The engine system of claim 1, wherein the T pipe includes:
an intake inflow portion connected to the intake line;
a recirculated exhaust gas inflow portion connected to the recirculation line; and
a mixed gas exhaust portion in which the fresh air flowing into the intake inflow portion and the recirculated exhaust gas flowing into the recirculated exhaust gas inflow portion are mixed and the mixed gas is exhausted to the compressor of the turbocharger.

3. The engine system of claim 2, wherein an intake inlet is formed at the intake inflow portion,
a recirculation gas inlet is formed at the recirculated exhaust gas inflow portion,
a mixed gas outlet is formed at the mixed gas exhaust portion, and
the intake inlet, the recirculation gas inlet, and the mixed gas outlet communicate with each other.

4. The engine system of claim 1, wherein the hot-water pipe is disposed on an external circumference of the mixed gas exhaust portion.

5. The engine system of claim 1, wherein the hot-water pipe is connected to an engine cooling line in which the coolant for cooling the engine flows.

6. The engine system of claim 1, wherein the intake line, the recirculation line and the T pipe are integrally formed.
